(19) United States
(12) Patent Application Publication
(10) Pub. No.: US 2014/0143588 A1
(43) Pub. Date: May 22, 2014

(54) Instant Communication Error Indication From Slave

(71) Applicant: NOKIA CORPORATION, Espoo (FI)

(72) Inventor: Pekka E. Leinonen, Turku (FI)

(73) Assignee: Nokia Corporation, Espoo (FI)

(21) Appl. No.: 13/683,194

(22) Filed: Nov. 21, 2012

(51) Int. Cl. G06F 11/07

(52) U.S. Cl. CPC G06F 11/0793
USPC 714/2

(57) ABSTRACT

An apparatus comprises at least one processor and at least one memory including computer program code, the at least one memory and the computer program code configured, with the at least one processor, to cause the apparatus at least to perform at least commanding a slave node to activate an immediate error response mode; and receiving an instant response from the slave node in response to a communication error.

### TECHNOLOGICAL FIELD

Embodiments of the present invention relate generally to communication between a master node and a slave node and, more particularly, to methods and apparatuses for providing an instant communication error indication from the slave node.

### BACKGROUND

Communication environments can be quite varied. For example, with regard to a particular device or entity, communications may occur between different functionalities or different nodes within that device. Alternatively or additionally, communications may occur between a first node of a first device and a second node of a second device. Thus, in the context of this document, the term node may refer to a functionality in a single device wherein communication occurs, for example, between two nodes within the device. The term node is also intended to cover a functionality in one device which is able to communicate with a node in the form of a different device or a functionality in a different device. These functionalities may, but need not, be provided in the form of interconnecting devices, components, circuits, modules, or any of various combinations thereof.

### BRIEF SUMMARY

Pursuant to one set of exemplary embodiments, an apparatus comprises at least one processor and at least one memory including computer program code, the at least one memory and the computer program code configured, with the at least one processor, to cause the apparatus at least to perform at least commanding a slave node to activate an immediate error response mode; and receiving an instant response from the slave node in response to a communication error.

Pursuant to another set of exemplary embodiments, an apparatus comprises at least one processor and at least one memory including computer program code, the at least one memory and the computer program code configured, with the at least one processor, to cause the apparatus at least to perform at least receiving a command from a master node to activate an immediate error response mode; and transmitting an instant response to the master node in response to a communication error.

Pursuant to another set of exemplary embodiments, a method comprises commanding a slave node to activate an immediate error response mode; and receiving an instant response from the slave node in response to a communication error.

Pursuant to another set of exemplary embodiments, a method comprises receiving a command from a master node to activate an immediate error response mode; and transmitting an instant response to the master node in response to a communication error.

Pursuant to another set of exemplary embodiments, a computer program product includes at least one computer-readable storage medium having computer-executable program code instructions stored therein, the computer-executable program code instructions including program code instructions for at least commanding a slave node to activate an immediate error response mode; and receiving an instant response from the slave node in response to a communication error.

Pursuant to another set of exemplary embodiments, a computer program product includes at least one computer-readable storage medium having computer-executable program code instructions stored therein, the computer-executable program code instructions including program code instructions for at least receiving a command from a master node to activate an immediate error response mode; and transmitting an instant response to the master node in response to a communication error.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram showing an exemplary mobile device platform on which a set of embodiments of the present invention may be performed.

FIG. 2 is a hardware block diagram showing illustrative battery packs for use with the configuration of FIG. 1.

FIG. 3 is a data structure diagram setting forth functional layers for Master and Slave nodes in accordance with a set of exemplary embodiments of the present invention.

FIG. 4 is a data structure diagram illustrating the physical layer of FIG. 3 in greater detail.

FIG. 5 is a timing diagram setting forth an illustrative unicast/multicast word and an illustrative broadcast word for use in conjunction with various exemplary embodiments of the present invention.

FIG. 6 is a flowchart setting forth an operational sequence for confirming a sending of an Enable Interrupt (EINT) command on a communication line in accordance with a set of embodiments of the present invention.

FIG. 7 is a signaling diagram setting forth an illustrative time-pulled-down-low pulse and an illustrative time-pulled-up pulse for performing various exemplary embodiments of the present invention.

FIG. 8 is a data structure diagram showing a set of illustrative protocol function registers for performing various exemplary embodiments of the present invention.

### DETAILED DESCRIPTION

Illustratively, node-to-node communication may be managed in accordance with a protocol known as the Mobile Industry Process Interface (MIPI) Alliance Standard for Unified Protocol (UniPro) in which communication is built on a layered protocol for interconnecting devices, components, circuits, and modules. UniPro is a dual simplex protocol which uses a first line for transmitting (TX) and a second line for receiving (RX). A local device may request its RX line to be reset by indicating to a remote device to reinitialize its TX physical layer. By way of example, UniPro may be utilized in conjunction with cellular telephones, handheld computers, digital cameras, multimedia devices, and other types of electronic devices. UniPro allows these devices, as well as various components within these devices, to exchange data at a high data rate, with a low pin count, and at low energy per transferred bit.

High speed communication at low power levels may lead to occasional errors in received data. A Data Link layer may be employed which includes a protocol to automatically acknowledge correctly received data frames using asymmetric flow control (AFC) control frames. In addition, the Data Link layer may be employed to actively signal errors that can be detected at Level 2 (L2) using one or more negatively acknowledged (NAC) control frames. The most likely cause of an error at L2 is that a data frame was corrupted at the electrical level, for example due to noise or electromagnetic interference (EMI). This corruption results in an incorrect data or control frame checksum at the receiving node side, and will lead to an automatic retransmission of the data frame. Note that data frames are acknowledged (AFC) or negatively acknowledged (NAC). Corrupt control frames are detected by timers that monitor expected or required responses.

In a conventional MIPI BIF interface, the EINT command may become corrupted due to a disturbance in the communication line. Such a disturbance may be caused, for example, by a connector contact break during the transmission of an EINT command. Under these circumstances, a slave node is detecting a faulty word instead of the EINT command. If this happens, the slave node does not enter interrupt mode and therefore is unable to send interrupts. The capability of a master node to detect contact breaks may be limited. In many practical systems, only breaks of long duration during logical high levels can be readily detected. As a result, there are cases where the slave node is not in interrupt mode, but the master node is not aware of the problem.

Conventionally, certain errors in BIF words or commands that are sent by a master node to the slave node may be detected using a Transaction Query (TQ). Illustratively, the master node may represent a mobile phone, whereas the slave node may represent an integrated circuit in a battery pack. TQ is performed by means of normal communication using data words. In the case of an EINT command, performing a TQ is not possible because the EINT command changes the state of the communication line to interrupt mode. Data communication is not allowed during interrupt mode and, thus, sending TQ after EINT would not be feasible, because TQ command transmission during interrupt mode may be interpreted as an interrupt followed by erroneous Data Word. Unreliable EINT commands may decrease the overall attractiveness of utilizing interrupt mode communications. Confirmation of the sending of an EINT command may be improved, which further may improve the reliability of the system.

Small Computer System Interface (SCSI) is a set of standards for physically connecting and transferring data between computers and peripheral devices. The SCSI standards define commands, protocols, and electrical and optical interfaces. A Key Code Qualifier (KCQ) is an error-code returned by a SCSI device. When a SCSI target device returns a check condition in response to a command, the initiator may then issue a SCSI Request Sense command. The Request Sense Command is used to obtain sense data, including status and error information, from the target device. An initiator sends the command to a device and then retrieves the resulting sense data. The sense data can be used to indicate any of a broad range of operational conditions, from a success/normal condition, to a simple problem, to a serious hardware failure. However, a SCSI Request Sense Command is not useful in the context of an EINT command because the EINT command changes the state of the communication line to interrupt mode such that data communication is not allowed.

As indicated previously, a KCQ is an error-code returned by a SCSI device. This error code includes three fields, designated as K, C, and Q, which provide increasing levels of specificity about the error. The K field comprises a sense key of 4 bits, (byte 2 of Fixed sense data format). The C field comprises an additional sense code (ASC) of 8 bits (byte 12 of Fixed sense data format). A Q field comprises an additional sense code qualifier (ASCQ) of 8 bits, (byte 13 of Fixed sense data format). An initiating SCSI device may take action based on just the K field which indicates if the error is minor or major. Typically, all three fields are logically combined into a single KCQ having a 20-bit field. The specification for the target device will define the list of possible KCQ values.

In practice, there are many KCQ values which are common between different SCSI device types and different SCSI device vendors. For example, a set of KCQs deals with Unit Attention. A KCQ of 6 28 00 designates a not-ready to ready transition. A KCQ of 6 29 00 indicates that a device reset has occurred. Likewise, a KCQ of 6 29 03 indicates that a target reset has occurred. Thus, different information fields are included in the KCQs within the SCSI sense data sent by the target device, followed by a SCSI Request Sense command which is sent by the initiating device. Although the KCQ values provide information about different reset situations, the target device is not able to actually reset the communication line when the system is in the interrupt mode.

In situations where humans cannot constantly monitor a device or group of devices, a watchdog timer may be employed. Many devices need to be self-reliant, as it is not always practicable to wait for someone to reboot the device every time the software hangs. A watchdog timer is a timer implemented in hardware or software that triggers a system reset or other corrective action if a program, process, or subroutine neglects to regularly respond to a monitoring function. A normal response may include periodically writing a service pulse to the monitoring function. This response is often described colloquially as “kicking the dog”, “petting the dog”, “feeding the watchdog” or “waking the watchdog.” Failure to respond is often due to a fault condition such as a processor or other component hanging and indefinitely outputting a zero or a one. The purpose of the watchdog timer is to bring the system back from the unresponsive state to normal operation. One common use of watchdog timers is in embedded systems, where this specialized timer is often built into a microcontroller or microprocessor. Accordingly, a watchdog timer may be used to reset a slave node if the node hangs and has been outputting a zero or a one for an extended period of time. However, watchdog timers are not equipped to provide confirmation of the sending of an EINT command.

A method for resetting a master computer and a slave computer connected with a shared data bus is disclosed in U.S. Pat. No. 7,689,729. This method may be employed in situations where it is impractical or difficult to provide the slave computer with an internal slave-reset configuration. At least one data bus port of the master computer is configured as an output port. The output port is used by the master computer to provide the slave computer with a slave-reset configuration via the shared data bus. However, this resetting method does not provide confirmation of the sending of an EINT command.

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

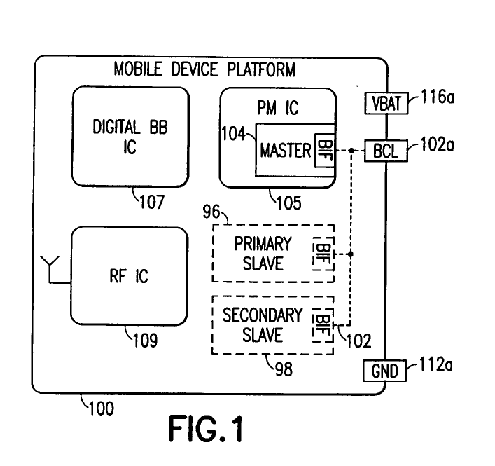

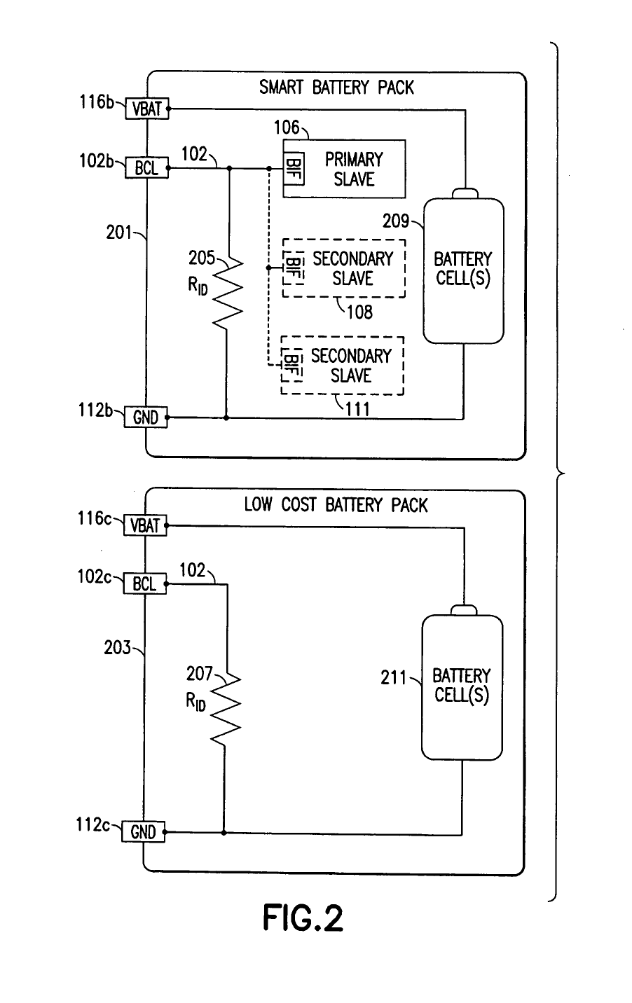

FIG. 1 is a block diagram showing an exemplary mobile device platform 100 on which a set of embodiments of the present invention may be performed. In exemplary embodiments of the invention, the mobile device platform 100 may be an electronic device, such as for example a mobile phone, a smart phone, or a portable computer, in accordance with at least one embodiment of the present invention. The mobile device platform 100 may include an RF IC 109 configured for communicating with a wireless node. Masters and slaves represent two basic types of nodes or devices that may be present on a battery interface (BIF) bus comprising a battery communication line (BCL) 102. The BCL 102 is a single wire interface. In the illustrative example of FIG. 1, only one Master 104 is present on the BCL 102, but two different types of Slaves are present, including a Primary Slave 96 and a Secondary Slave 98. In general, one or more Slave devices or nodes may be present on the BCL 102. The Primary Slave 96 and the Secondary Slave 98 may be located within a battery pack, as will be described in more detail hereinafter in conjunction with FIG. 2. Alternatively or additionally, the Primary Slave 96 (FIG.1), or the Secondary Slave 98, or both of these Slaves, may be located within a host system.

The Master 104 may be provided as part of a power management IC (PM IC) 105. Alternatively or additionally, the Master 104 could be placed on a digital baseband (BB) IC 107, illustratively using low-voltage semiconductor processes. Low-voltage semiconductor processes are possible due to the fact that the BCL 102 may convey signals using a BIF protocol which provides for scalable electrical signaling levels. The BIF protocol may be employed in situations where the Master 104 is implemented in hardware, or where a combination of software and a General Purpose Input Output (GPIO) pin is used to implement the Master 104, or where a combination of hardware and software is used to implement the Master 104.

FIG. 2 is a hardware block diagram showing illustrative battery packs for use with the configuration of FIG. 1. The BIF protocol supports a low cost battery pack 203 (FIG. 2) and a smart battery pack 201. For example, if the smart battery pack 201 (FIG. 2) is to be connected to the mobile device platform 100 (FIG. 1), then a VBAT terminal 116a on the mobile device platform 100 is placed in contact with a corresponding VBAT terminal 116b (FIG. 2) on the smart battery pack 201. Similarly, a BCL terminal 102a (FIG. 1) on the mobile device platform 100 is placed in contact with a corresponding BCL terminal 102b (FIG. 2) on the smart battery pack 201. Likewise, a ground terminal 112a (FIG. 1) on the mobile device platform 100 is placed in contact with a corresponding ground terminal 112b (FIG. 2) on the smart battery pack 201.

Pursuant to another example, if the low cost battery pack 203 (FIG. 2) is to be connected to the mobile device platform 100 (FIG. 1), then the VBAT terminal 116a on the mobile device platform 100 is placed in contact with a corresponding VBAT terminal 116c (FIG. 2) on the low cost battery pack 203. Similarly, the BCL terminal 102a (FIG. 1) on the mobile device platform 100 is placed in contact with a corresponding BCL terminal 102c (FIG. 2) on the low cost battery pack 203. Likewise, the ground terminal 112a (FIG. 1) on the mobile device platform 100 is placed in contact with a corresponding ground terminal 112c (FIG. 2) on the low cost battery pack 203.

The smart battery pack 201 (FIG. 2) includes a pull-down resistor (R_{ID}) 205, and the low-cost battery pack 203 also includes a pull-down resistor (R_{ID}) 207. The R_{ID} 205 is connected to the battery communication line (BCL) 102 (FIGS. 1 and 2), and the R_{ID} 207 (FIG. 2) is also connected to the BCL 102. The resistance value of the respective R_{IDS} 205, 207 may be selected so as enable an identification of whether an unknown battery pack is a smart battery pack 201 or a low cost battery pack 203. In the case of the low cost battery pack 203, the resistance value of R_{ID} 207 may optionally be further selected so as to identify any of various electrical characteristics associated with one or more battery cells 211, such as voltage or ampere-hours of capacity, or any of various other electrical parameters. The R_{ID} 205 and the R_{ID} 207 may also be used to implement fast battery pack presence detection. If a smart battery pack 201 is disconnected, the R_{ID} 205 also plays the role of pulling the BCL102 line down, and thereby placing a Primary Slave 106 (FIG. 2), a Secondary Slave 108, and an additional Secondary Slave 111 (FIG. 2) into a power-down mode.

A BIF Master 104 (FIG. 1) may address up to 256 Slave devices connected to the BCL 102 line in total, by using so-called short 8-bit addressing. At a minimum, the Master 104 functions include physical layer and protocol functions. The Master 104 may also implement fast presence battery pack detection and low cost battery identification (R_{ID} value measurement) functions.

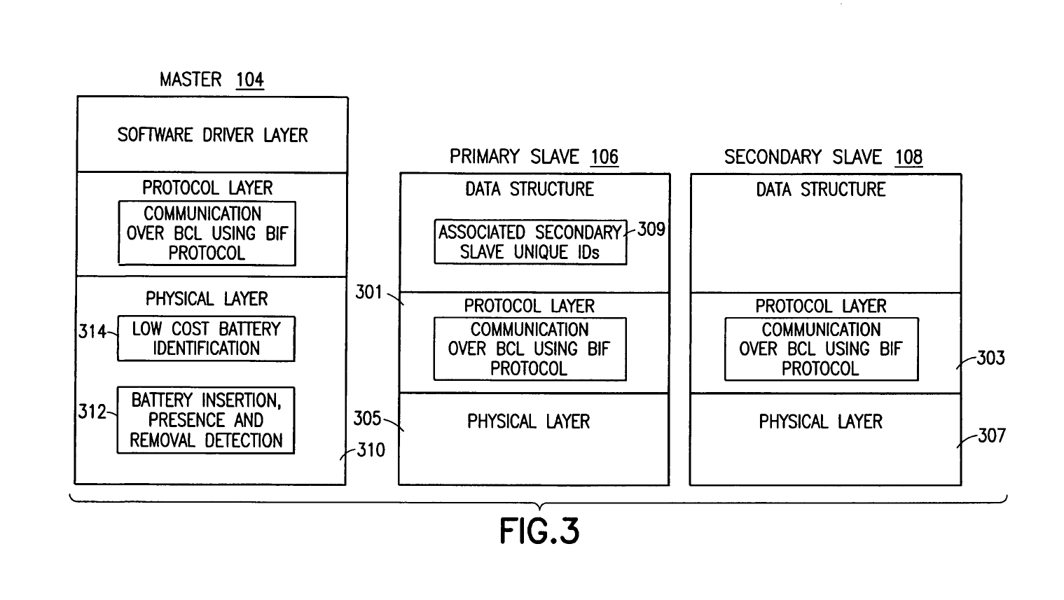

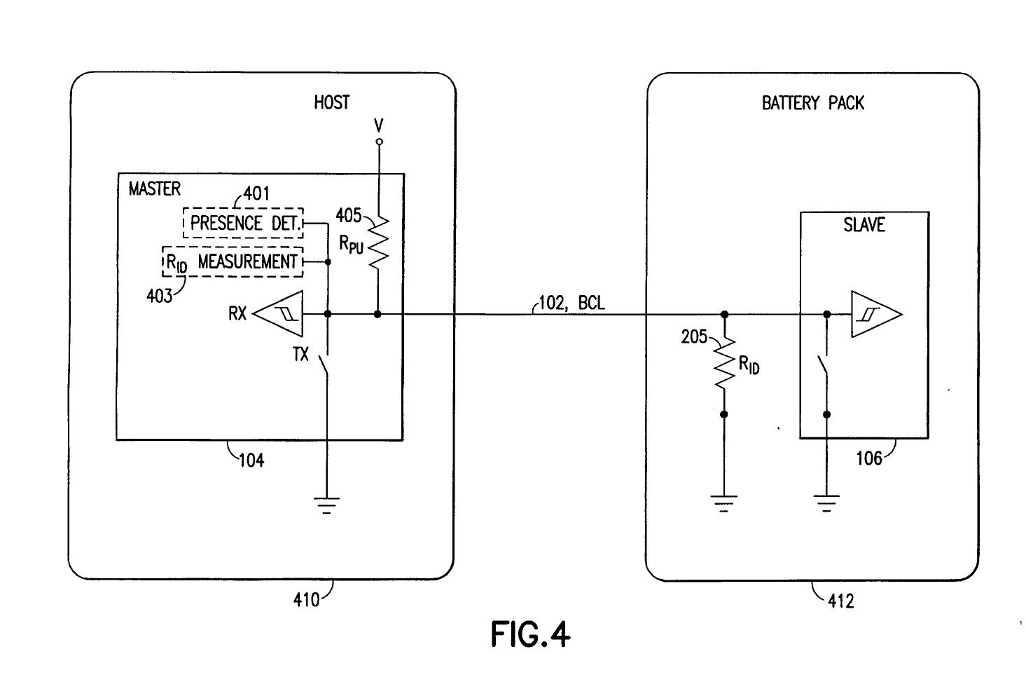

FIG. 3 is a data structure diagram setting forth functional layers for Master and Slave nodes in accordance with a set of exemplary embodiments of the present invention. A Slave device is either a Primary Slave 96, 106 or a Secondary Slave 98, 108, 111 (FIGS. 1-3). The Primary Slaves 96, 106 have a protocol layer 301 and a physical layer 305 (FIG. 3). Similarly, the Secondary Slaves 98, 108 have a protocol layer 303 and a physical layer 307. Each of the respective Primary Slaves 96, 106 also include standard device identification data such as associated Secondary Slave unique identifiers (IDs) for the corresponding Secondary Slaves 98, 108 and optional additional secondary slaves such as Secondary Slave 111 (FIG. 2). Illustratively, the Primary Slave 106 (FIG. 3) and the Secondary Slave 108 are each equipped with 64k bit of addressable memory space. Some or all of the memory space in the Primary Slave 106 or the Secondary Slave 108, or both, may be used to store a battery parameter object. A typical battery parameter object contains, for example, information about a battery model, capacity, chemistry, charging and discharging, and aging parameters. Other information may be included in addition to the foregoing. The idea is to provide a method for battery pack makers to pass various parameters of a battery pack 412 (FIG. 4) to a host 410 of the mobile device platform 100 (FIG. 1).

If the Master 104 has been configured to support the low cost battery pack 203 (FIG. 2), then a BIF physical layer 310 of the Master 104 may include a low cost battery identification 314 mechanism such as circuitry for measuring the R_{ID} 207 (FIG. 2). If the Master 104 (FIG. 3) has been configured to support fast presence detection of the battery pack 201, 203 (FIG. 2), then the BIF physical layer 310 (FIG. 3) may include a battery insertion, presence, and removal detection 312 circuit in the Master 104. R_{ID} value measurement may utilize, for example, an analog-to-digital converter (ADC) with a 10-bit resolution. The fast presence detection implementation may be performed in any of several ways. BIF specifies only a range of time for the operation.

Pursuant to some system applications, there may be only one Primary Slave 106 per subsystem, i.e. smart battery pack 201 (FIG. 2) or host system. The Primary Slave 106 (FIG. 3) may be able to store the unique IDs for all secondary slaves within the same subsystem. The storing of these unique IDs may, but need not, represent the only fundamental difference between the Primary Slave 106 and the Secondary Slave 108. One idea behind the slave arrangement of FIG. 3 is to enable the use of short (8-bit) device addresses in practical applications, and thus speed up the device discovery process in the bus and Slave 106, 108 device short address assignment for the Master 104. Otherwise, the Master 104 would have to perform address searching and addressing with full unique IDs (typically 80-bits).

FIG. 4 is a data structure diagram illustrating the physical layer 305, 307 of FIG. 3 in greater detail. BIF uses a single wire, open-drain communication interface which is shown in FIGS. 1 and 2 as the BCL 102. As indicated previously, BIF supports a single low cost battery pack 203 (FIG. 2) or a single smart battery pack 201 on the BCL 102. Thus, a battery pack 412 (FIG. 4) may represent any of the low cost battery pack 203 (FIG. 2) or the smart battery pack 201. For example, if the battery pack 412 (FIG. 4) is a smart battery pack 201, then the battery pack 412 includes the resistor R_{ID} 205.

If the Master 104 (FIGS. 3 and 4) has been configured to support the low cost battery pack 203 (FIG. 2), then the low cost battery identification 314 (FIG. 3) mechanism may comprise RID measurement 403 (FIG. 4) circuitry for measuring the RID 207 (FIG. 2). If the Master 104 (FIG. 3) has been configured to support fast presence detection of the battery pack 201, 203 (FIG. 2), then the battery insertion, presence, and removal detection 312 circuit (FIG. 3) may be implemented using a presence detector 401 (FIG. 4).

A communication pull-up resistor 405 or current source is provided by a host 410. Thus, a signal high level is set by the host 410 and is scalable over a desired range of voltages as, for example, from 1.1V to 2.8V. This functionality means that the host 410 may, but need not, be implemented using low voltage semiconductor processes. Minimum rise and fall times may be defined to limit potential electrical magnetic interference (EMI) issues.

The BIF protocol is designed as a data transport interface. Battery-specific applications, such as temperature measurement and authentication, make use of the protocol. Data transport and battery application usages are separated. Some benefits of the BIF protocol are that it is software or hardware implementable, and communication data rates are scalable, for example, between 2 kbit/s-250 kbit/s (on average). The minimum data rate may be extended down to approximately 2 kbit/s because many systems provide a 32.768 kHz clock due to the necessity of having a real time clock. A 32.768 kHz clock produces about 2 kbit/s data rate in a typical BIF protocol implementation. The maximum data rate was limited to 250 kbit/s to minimize the Slave device receiver size. The maximum calculated use case suggests that even ˜100 kbit/s would be sufficient for some time.

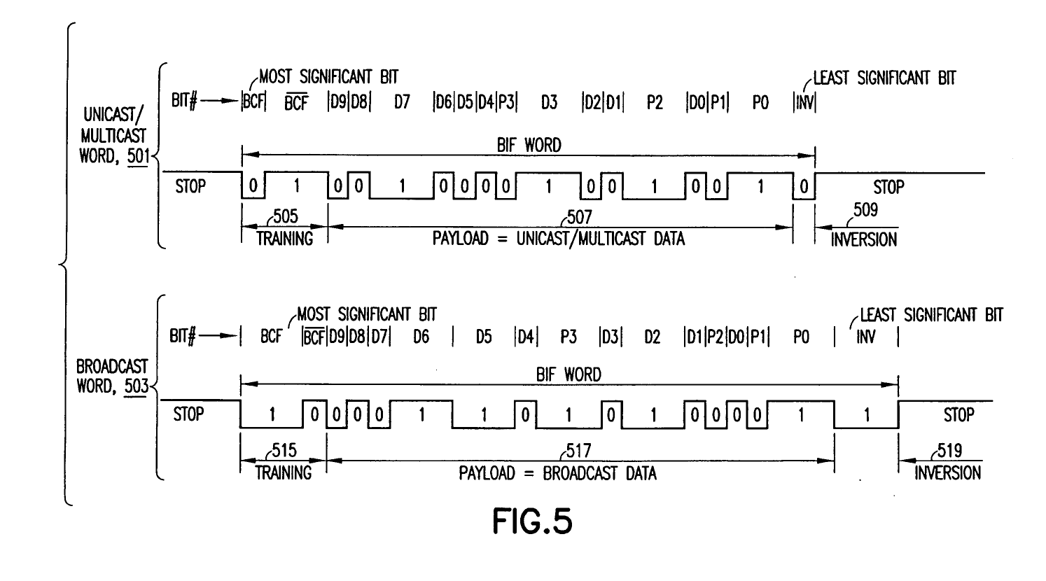

FIG. 5 is a timing diagram setting forth an illustrative unicast/multicast word 501 and an illustrative broadcast word 503 for performing various exemplary embodiments of the present invention. BIF communication on the BCL 102 (FIGS. 1, 2, and 4) is initiated by the Master 104 and is based on a data word. The Master 104 defines a communication speed at the beginning of every word, and the addressed Slave 106 (FIG. 2) uses that speed in its response. Thus, each word exchange between the Master 104 and the Slave 106 could, but need not, happen at a different speed.

Returning now to FIG. 5, by way of example, each word may be a 17-bit data word. Each 17-bit data word illustratively may include the following elements: a training sequence 505, 515 (illustratively, 2 bits), a payload 507, 517 (for example, 10 bits), a set of parity bits (illustratively, 4 bits) in the payload 507, 517, and an inversion bit 509, 519 (for example, 1 bit). A data word, such as the unicast/multicast word 501 or the broadcast word 503, can carry a command, a device or register address, read data or write data. The training sequence 505, 515 bits are used to indicate a communication speed and also provide an indication as to whether a given word is a broadcast word 503 versus a unicast/multicast word 501. The broadcast word 503 is intended for all Slaves 106, 108 (FIG. 2), whereas the unicast/multicast word 501 (FIG. 5) is intended only for a certain Slave 106 or group of Slaves 106, 108.

The payload 507, 517 represents the actual data to be transported. The parity bits of the payload 507, 517 may, but need not, conform to Hamming-15 coding, and are used to detect possible communication errors. Strong detection of communication errors is important, especially for a battery interface, because of the physical connector on the BCL line 102 (FIG. 2) which connects the battery pack 201, 203 (FIG. 2) to the host 410 (FIG. 4). Also, mobile devices are exposed to abuse and shaking by nature.

With reference to FIG. 5, BIF protocol signaling may, but need not, be based on Time Distance coding, i.e. based on time between changes of the signal level. Logical “0” may be defined as a one time unit and logical “1” is a three time units, i.e. a logical “1” can be either a three time unit long high or low state signal on the BCL line 102 (FIG. 4). Between each word there may be a requirement for at least 5 time units (stop). The inversion bit 509, 519 is included due to the nature of BIF protocol symbol signaling. If more than half of the data word bits are logical “1”'s (3 time units each), all bits in the word are inverted and then the word contains more “0”'s (1 time unit each). Thus, the overall time needed to send the entire word is shorter. This idea makes data bandwidth more efficient and less dependent on actual data content.

The BIF protocol includes built-in features to facilitate slave interrupts and task control. Task control provides status information (busy information, etc.) for each task on a given Slave 106, 108 (FIG. 2). This may be an advantageous feature in some system applications where the Slaves 106, 108 are slow due to tight cost requirements. Interrupts may be used to offload the host 410 (FIG. 4), for example, by taking care of battery temperature, voltage or current monitoring functions, and interrupting the host 410 only when needed. Slaves will enter into interrupt mode when the Master 104 (FIGS. 1, 3, and 4) sends an Enable Interrupt (EINT) command to all Slaves 106, 108 on the BCL 102 (FIGS. 2 and 4). During interrupt mode, there is no other communication on the BCL 102 line. The BIF protocol defines three power modes for the Slaves 106, 108: Active, Standby and Power-down. Power-down mode has been designed so that when a battery pack 412 (FIG. 4) is removed for longer than a defined time, the Slave 106 inside the battery pack 412 will go to power-down mode automatically.

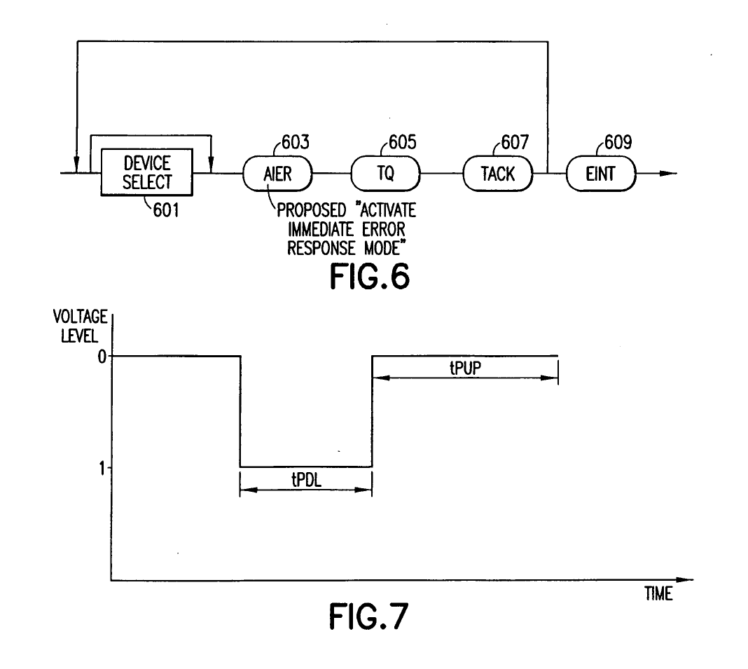

FIG. 6 is a flowchart setting forth an operational sequence for confirming a sending of an Enable Interrupt (EINT) command on a communication line in accordance with a set of embodiments of the present invention. Conventionally, certain errors in BIF words or commands that are sent by the Master 104 (FIG. 1) to the Slave 106 or 108 (FIG. 2) can be detected using a Transaction Query (TQ). TQ is performed by means of normal communication using data words. In the case of an EINT command, performing a TQ is not possible because the EINT command changes the state of the communication line to interrupt mode. Data communication is not allowed during interrupt mode and, thus, sending a TQ immediately after an EINT command may be ineffective.

The BIF protocol provides a Master 104—multi Slave 106, 108 (FIG. 2) type of interface where both data from the Master 104 to one or more Slaves 106, 108, as well as data from one or more Slaves 106, 108 to the Master 104 is sent using the 17-bit data words described previously in conjunction with FIG. 5. These data words include a 4-bit Hamming code. This means that receiving party is able to detect certain types of errors. When the Master 104 (FIG. 1) is sending a read command, the Master 104 expects to receive one or more data words back from one or more of the Slaves 106 or 108 (FIG. 2). This means that, if the Master 104 receives a requested amount of data words back from the Slave 106 or 108, then the Master 104 knows that the read command was successfully decoded by the Slave 106 or 108.

When the Master 104 sends a write command followed by data from the Master 104 to the Slave 106 or 108, the Master 104 does not receive any automatic response even though one or more of the data words may become corrupted. Because of this, the BIF protocol includes the Transaction Query (TQ) command described previously. When the Slave 106 or 108 receives the TQ command, the Slave 106 or 108 answers with a Transaction Acknowledge (TA) message.

TQ cannot be sent after an EINT command is sent, because after EINT, no traffic other than interrupts are expected. So, in MIPI BIF specification Version 1.0, there is no mechanism to verify that Slaves 106, 108 were able to receive the EINT command correctly. If for example there is a connector contact break on the BCL 102 line at the time when EINT command is sent, one or more Slaves 106, 108 may not enter the interrupt mode.

It is conceivable that some newly proposed interface may attempt to include an acknowledge mechanism not only for normal data word transmission from the Master 104 to the Slaves 106, 108, but also for the EINT command. EINT command is a broadcast command, which means slaves 106, 108, 111 (FIG. 2) connected to the BCL 102 line receive the EINT command at the same time. If the Slaves 106, 108, 111 would, for example, acknowledge the EINT command by driving the BCL 102 line to a logical low level for confirming that the EINT command was decoded correctly, then the Master 104 would not be able to know which of the Slaves 106, 108, 111 were sending an acknowledgement back to the Master 104.

If the sending of the EINT command is not reliable, then interrupt polling may be one option. However, polling increases power consumption and also requires small amount of Master side CPU processing time.

The operational sequence of FIG. 6 provides for one or more Slaves 106, 108, 111 (FIG. 2) in a Master 104 (FIG. 1)—multi-Slave 106, 108, 111 (FIG. 2) system to send out an instant response in response to a communication error. At block 601, the Master 104 (FIG. 1) performs a device select operation by selecting one or more Slaves 106, 108, 111 (FIG. 2) which are to send out an instant response in response to a communication error on the BCL 102 line (FIGS. 1, 2, and 4). Enabling of this instant response may, but need not, be performed on a need basis by the Master 104 (FIG. 1). In other words, the. Slaves 106, 108, 111 (FIG. 2) are able to send this instant response to the communication error only if an instant error response feature in the Slave 106, 108, or 111 is enabled by the Master 104 (FIG. 1). Whereas some communication errors may be communicated conventionally using data word based communication, communication error handling for some critical communication, including for example EINT commands, may be handled using the foregoing instant response methodology.

The operational sequence of FIG. 6 progresses to block 603 where the Master 104 (FIG. 1) sends an “Activate Immediate Error Response Mode” (AIER) command to one or more Slaves 106, 108, 111. This AIER command is a proposed new command that is not included in the MIPI Alliance Battery Interface Specification Version 1.0. However, the AIER command may be incorporated into a BIF Bus Commands table which is set forth as Table 4 in the aforementioned MIPI Specification. In response to receiving the AIER command, the one or more Slaves 106, 108, 111 (FIG. 2) are placed into an “Immediate Error Response Mode”.

In response to an error in decoding a data word at one of the Slaves 106, 108, or 111 (FIG. 2), the Slave undergoing the data word decoding error issues a low pulse for a first predetermined or specified duration of time denoted as “time Pulled Down Low” (tPDL) in case of error. Such an error could be caused, for example, by a failed hamming code or a timing violation when receiving logical ones and logical zeroes. When the AIER command is received by a Slave 106, 108, the Slave enters a mode where the logical low signal or pulse denoted by tPDL is ideally generated as soon as possible after a corrupted word has been detected. Immediate Error Response Mode is disabled by an EINT command or by any other mode transition. If the Master 104 (FIG. 1) detects or senses the logical low signal or pulse of tPDL in the BCL 102 line, then the Master 104 should wait until a logical high signal or pulse having a second predetermined or specified time duration denoted as tPUP is sent on the BCL 102 line before issuing new commands. This logical high signal or pulse denoted as “time Pulled UP” (tPUP) may be sent on the BCL 102 by either the Master 104 or a Slave 106, 108, as will be described in greater detail hereinafter. FIG. 7 is a signaling diagram setting forth an illustrative time-pulled-down-low pulse (tPDL) and an illustrative time-pulled-up pulse (tPUP) for performing various exemplary embodiments of the present invention.

The AIER command may, but need not, be a unicast type of command. Pursuant to a unicast command, only a selected Slave 106 or a set of selected Slaves 106, 108 (FIG. 2) will receive the AIER command from the Master 104 (FIG. 1). In some circumstances, having only the selected slave receiving the AIER command may enhance reliability.

Next, at block 605 (FIG. 6), a TQ command is issued by the Master 104 (FIG. 1). The TQ command may, but need not, be issued separately for each Slave 106, 108, 111 (FIG. 2) to ensure, on a Slave by Slave basis, that the AIER command of block 603 (FIG. 6) was decoded correctly by one or more of the Slaves 106, 108, 111 (FIG. 2). A mechanism for detecting a low time of tPDL on the BCL 102 line (FIGS. 1, 2, and 4), wherein tPDL is less than a desired threshold value, may optionally be added to the Master 104 (FIG. 1) so that the Master 104 could add or send out the logical high signal or pulse having a second predetermined or specified time duration of tPUP after the logical low signal or pulse of time duration tPDL occurring on the BCL 102 line. The high time of tPUP would allow one or more Slaves 106, 108, 111 (FIG. 2) to recover from a reset.

The operational sequence of FIG. 6 progresses to block 607 where a TACK response is sent by one or more of the Slaves 106, 108, 111 (FIG. 2) and received by the Master 104 (FIG. 1). At block 609 (FIG. 6), an EINT command is sent from the Master 104 (FIG. 1) to one or more Slaves 106, 108, 111 (FIG. 2). If the EINT command of block 609 (FIG. 6) becomes corrupted, then the logical low signal or pulse tPDL would be generated by one or more Slaves 106, 108 (FIG. 2).

The procedure of FIG. 6 may be advantageous in that EINT command decoding errors at the Slave 106, 108, 111 (FIG. 2) side are visible to the Master 104 (FIG. 1), and thereby may increase reliability of the BIF interrupt feature. Optionally or additionally, a Master 104 side software implementation above a HAL software layer may be used to control when to enable or disable the new features described with reference to FIG. 6. Alternatively or additionally, selection as to whether or not to enable these new features may be performed on a Slave by Slave basis. Performing these features on a Slave by Slave basis may render the operational sequence of FIG. 6 backwards compatible with existing system topologies.

In principle, it may be advantageous in many “Master 104—multi Slave 106, 108” systems (FIGS. 1 and 2) for the Master 104 to have as much control as possible. If the Slaves 106, 108 (FIG. 2) are given permission for instant error response, pursuant to some system applications, it may be advantageous for the Master 104 to remain as the authority for granting such permission. In most system applications, only the Master 104 and not the Slaves 106, 108 may be capable of sophisticated decision making. For example in case of BIF, Slaves 106, 108 may be fixed, simple, devices based entirely on hardware, whereas the Master 104 may be controlled by software.

The Slave 106 or 108 may exit the Immediate Error Response Mode by one or more mode transitions which may, but need not, comprise a mode transition from an Interrupt mode to an Active mode, or from a Standby mode to the Active mode, from a Power Down mode to the Active mode. Also, the Immediate Error Response Mode may be exited or terminated by a broadcast command, a multicast command, or a unicast command.

Although the operational sequence of FIG. 6 may be used to improve the MIPI BIF Specification V1.0, it should be understood that this operational sequence is equally applicable to any of a broad range of hardware interfaces.

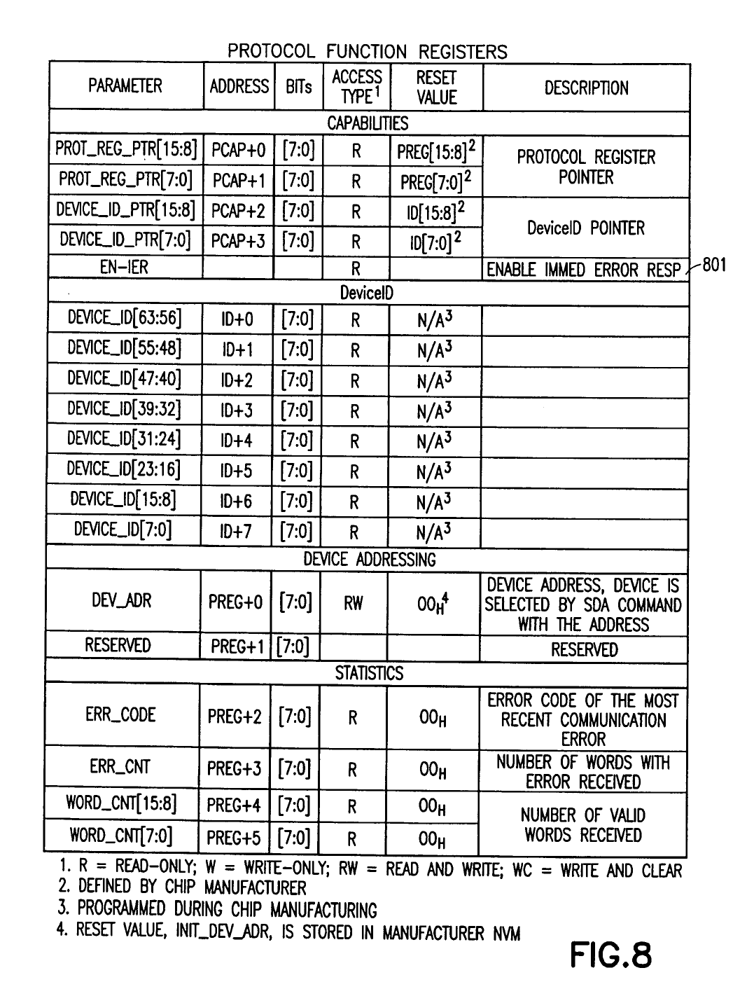

FIG. 8 is a data structure diagram showing a set of illustrative protocol function registers for performing various exemplary embodiments of the present invention. The protocol function registers of FIG. 8 are substantially similar to those presented in the MIPI BIF Specification V1.0 at Table 13, with the exception that a new register bit called EN_IER (Enable Immediate Error Response) 801 has been added to these protocol function registers. For purposes of illustration, the address of the EN_IER 801 register bit may, but need not, be at preg+1 or preg+6. The access type of the EN_IER 801 register bit may be read-write (RW). The EN_IER 801 register bit has a default state of “0” or “0B” where no action is taken. When the EN_IER 801 register bit is active (“1”), the Slave 106, 108 (FIG. 2) resets itself and drives the BCL 102 line to a logical low level for the duration tPDL immediately after the Slave detects an error in the BCL line. This low pulse of duration tPDL is sent only in the case of an error. This error also resets the Slave 106, 108 (FIG. 2).

If the Master 104 (FIG. 1) sees the low pulse tPDL during an Active Mode or an Interrupt Mode, then the Master may reinitiate communication with the Slaves 106 or 108 (FIG. 2). For many practical applications, the EN_IER 801 (FIG. 8) register bit is kept active only when TQ is not applicable. Many master to slave transmission errors can be handled by TQ, but in some cases use of the EN_IER 801 register bit may be beneficial. Some illustrative examples of these cases include:

EINT (Enable Interrupt) command transmission;

BRES (Bus Reset) command transmission;

PDWN (Enter Power Down Mode) command transmission; and/or

STBY (Enter Standby Mode) command transmission.

Before transmitting these commands (EINT, BRES, PDWN, or STBY), a host system, such as the mobile device platform 100 (FIG. 1), may enable Immediate Error Response Mode for one or more Slaves 106 or 108 (FIG. 2) connected to the BCL 102 line. When Immediate Error Response Mode is enabled, the Slave 106 or 108 gives an instant error response by driving the BCL 102 line low for the time period of tPDL. When Immediate Error Response Mode is enabled, the Master 104 (FIG. 1) should monitor the BCL 102 line in order to detect errors reported by the Immediate Error Response Mode.

The EN_IER 801 (FIG. 8) bit may be disabled (set to “0”) automatically by the Slave 106 or 108 (FIG. 2) during any of the following mode transitions:

from Powerdown Mode to Active Mode;

from Standby Mode to Active Mode; and/or

from Interrupt Mode to Active Mode.

Both enabling and Disabling of EN_IER 801 (FIG. 8) may also be done by writing to the EN_IER 801 register bit. Illustratively, Immediate Error Response Mode should not be used for communication which can be handled by a TQ, because otherwise the BCL 102 (FIG. 2) line may become stuck or indefinitely latched at a logical low level or a logical high level when subjected to an unstable environment where many contact breaks occur.

Illustratively, the EN_IER 801 (FIG. 8) register bit is used in situations where both a Slave 106 (FIG. 2) or a Master 104 (FIG. 1) are supporting this new bit. In multi-slave systems, it would be possible to utilize this new feature if at least one slave supports it. However, the Instant Error Response pulse would cause a hard reset to all slaves, regardless of whether or not a particular slave is equipped to recognize the EN_IER 801 bit.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured, with the at least one processor, to cause the apparatus at least to perform at least:
commanding a slave node to activate an immediate error response mode; and
receiving an instant response from the slave node in response to a communication error.

2. The apparatus of claim 1 wherein the communication error occurs on a battery communication line.

3. The apparatus of claim 1 wherein the commanding is performed using a unicast command.

4. The apparatus of claim 1 wherein the instant response comprises a low pulse having a first predetermined or specified time duration.

5. The apparatus of claim 4 further comprising sending out a logical high signal having a second predetermined or specified time duration.

6. The apparatus of claim 4 wherein the second predetermined or specified time duration is selected such that the slave node recovers from a reset.

7. An apparatus comprising at least one processor and at least one memory including computer program code, the at least one memory and the computer program code configured, with the at least one processor, to cause the apparatus at least to perform at least:
receiving a command from a master node to activate an immediate error response mode; and
transmitting an instant response to the master node in response to a communication error.

8. The apparatus of claim 7 wherein the communication error occurs on a battery communication line.

9. The apparatus of claim 7 wherein the commanding is performed using a unicast command.

10. The apparatus of claim 7 wherein the instant response comprises a low pulse having a first predetermined or specified time duration.

11. The apparatus of claim 10 further comprising receiving a logical high signal having a second predetermined or specified time duration.

12. The apparatus of claim 11 wherein the second predetermined or specified time duration is selected such that the apparatus recovers from a reset.

13. A method comprising:
commanding a slave node to activate an immediate error response mode; and
receiving an instant response from the slave node in response to a communication error.

14. The method of claim 13 wherein the communication error occurs on a battery communication line.

15. The method of claim 13 wherein the instant response comprises a low pulse having a first predetermined or specified time duration.

16. The method of claim 15 further comprising sending out a logical high signal having a second predetermined or specified time duration, wherein the second predetermined or specified time duration is selected such that the slave node recovers from a reset.

17. A method comprising:
receiving a command from a master node to activate an immediate error response mode; and
transmitting an instant response to the master node in response to a communication error.

18. The method of claim 17 wherein the communication error occurs on a battery communication line.

19. The method of claim 17 wherein the instant response comprises a low pulse having a first predetermined or specified time duration.

20. The method of claim 19 further comprising receiving a logical high signal having a second predetermined or specified time duration, wherein the second predetermined or specified time duration is selected such that the apparatus recovers from a reset.
